(19) United States
(12) Patent Application Publication
(10) Pub. No.: US 2016/0347011 A1
(43) Pub. Date: Dec. 1, 2016

(54) TIRE SEALANT DISPENSING DEVICE

(71) Applicant: Beto Engineering & Marketing Co., Ltd., Taichung (TW)

(72) Inventor: Lo Pin WANG, Taichung (TW)

(21) Appl. No.: 14/724,994

(22) Filed: May 29, 2015

(51) Int. Cl. B29C 73/16; B60S 5/04; B29C 73/02

(52) U.S. Cl. CPC B29C 73/166; B29C 73/025; B60S 5/04

(57) ABSTRACT

A tire sealant dispensing device includes a tire repairing container for receiving a sealant, a casing attached to a mouth of the tire repairing container and having an inlet conduit and an outlet conduit, a pipe is disposed in the container and includes one end coupled to the casing and includes a bore for directing the pressurized air to flow through the bore of the pipe and to flow into a base portion of the container without flowing through the sealant, for allowing the tire sealant to be effectively supplied out through the outlet conduit of the casing and to seal and inflate the inflatable objects.

### BACKGROUND OF THE INVENTION

1. Field of the Invention

The present invention relates to a tire sealing and inflating assembly for sealing and inflating an inflatable object, and more particularly to a tire sealant dispensing device including an improved and simplified tire repairing container for quickly coupling and attaching and securing to a pressurized air reservoir and for allowing the tire sealant to be effectively supplied to seal and inflate the inflatable objects.

2. Description of the Prior Art

Various kinds of typical air compressing devices have been developed and comprise a cylinder housing, a piston slidably received in the cylinder housing and actuated with a motor in a reciprocating action, in order to generate a pressurized air of a greater air pressure and a decreased flowing quantity, and a pressure tight container for receiving a sealant and for selectively supplying the sealant to seal and inflate the inflatable objects, such as vehicle tires, air beds, air cushions, hovercrafts, etc.

For example, U.S. Pat. No. 6,176,285 to Gerresheim et al., U.S. Pat. No. 6,283,172 to Thurner, U.S. Pat. No. 6,345,650 to Paasch et al., U.S. Pat. No. 6,454,892 to Gerresheim et al., U.S. Pat. No. 6,889,723 to Gerresheim et al., U.S. Pat. No. 7,021,348 to Eriksen et al., U.S. Pat. No. 7,178,564 to Kojima et al., U.S. Pat. No. 8,016,002 to Yoshida et al., and U.S. Pat. No. 8,671,995 to Chou disclose several of the typical preparations for the sealing of tires with punctures, and repairing apparatuses for the sealing and pumping up of tires and tires with an integrated sealant comprising a pressure tight container that is coupled to a pressurized air cartridge.

However, the pressure tight container and the pressurized air cartridge are coupled together with a shut off valve, a gas outlet, a gas inlet and may not be easily disengaged from each other, and an outlet valve and an additional riser tube are further required to be attached or mounted to the upper portion of the pressure tight container for allowing the sealant to be selectively supplied to seal and inflate the inflatable objects, but may not be easily connected or coupled to the air compressor devices. In addition, the sealant may not be easily forced to flow upwardly and out through the pressure tight container by the pressurized air particularly in the cold environment where the pressurized air may not easily flow through the sealant. The typical tire sealing and inflating apparatuses comprise a complicated structure that is adverse for manufacturing and assembling purposes.

The present invention has arisen to mitigate and/or obviate the afore-described disadvantages of the conventional air compressor devices and/or sealing and inflating devices for sealing and inflating the inflatable objects.

### SUMMARY OF THE INVENTION

The primary objective of the present invention is to provide a tire sealant dispensing device including an improved and simplified tire repairing container for quickly coupling and attaching and securing to a pressurized air reservoir and for allowing the tire sealant to be effectively supplied to seal and inflate the inflatable objects.

In accordance with one aspect of the invention, there is provided a tire sealant dispensing device comprising a tire repairing container including a chamber formed therein for receiving a sealant, and including a mouth formed therein, a casing attached to the mouth of the tire repairing container, and the casing including a compartment formed therein for engaging the mouth of the tire repairing container, and the casing including an inlet conduit formed therein and communicating with the compartment of the casing and communicating with the chamber of the tire repairing container for guiding a pressurized air to flow through the inlet conduit of the casing and then into the chamber of the tire repairing container, and the casing including an outlet conduit formed therein and communicating with the compartment of the casing and the chamber of the tire repairing container for allowing the sealant in the chamber of the tire repairing container to selectively flow out through the outlet conduit of the casing, and a pipe disposed in the chamber of the tire repairing container, and the pipe including a first end coupled to the casing, and the pipe including a bore formed therein and communicating with the inlet conduit of the casing for directing and guiding the pressurized air to flow through the bore of the pipe and to flow into a base portion of the tire repairing container, and the tire sealant dispensing device includes an improved and simplified structure or configuration that may be made or manufactured with a greatly decreased manufacturing cost and a reduced making or manufacturing procedure.

The casing includes an entrance formed therein and communicating with the inlet conduit of the casing for coupling to an inlet tube, and then to a pressurized air reservoir. The casing includes an outlet tube coupling to the outlet conduit of the casing for supplying the sealant to seal and inflate the inflatable objects or the like.

The tire repairing container includes an outer thread formed on an outer peripheral portion of the mouth, and the casing includes an inner thread formed therein for engaging with the outer thread of the tire repairing container and for detachably attaching the casing to the mouth of the tire repairing container, and for blocking or enclosing the mouth of the tire repairing container with the casing and for confining and retaining the sealant within the chamber of the tire repairing container.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a tire sealant dispensing device in accordance with the present invention;

FIG. 2 is a perspective view of the tire sealant dispensing device;

FIG. 3 is a cross sectional view illustrating a tire repairing container of the tire sealant dispensing device, taken along lines 3-3 of FIG. 2; and

FIG. 4 is a cross sectional view similar to FIG. 3, illustrating the operation of the tire sealant dispensing device.

### DETAILED DESCRIPTION OF THE PREFERRED EMBODIMENT

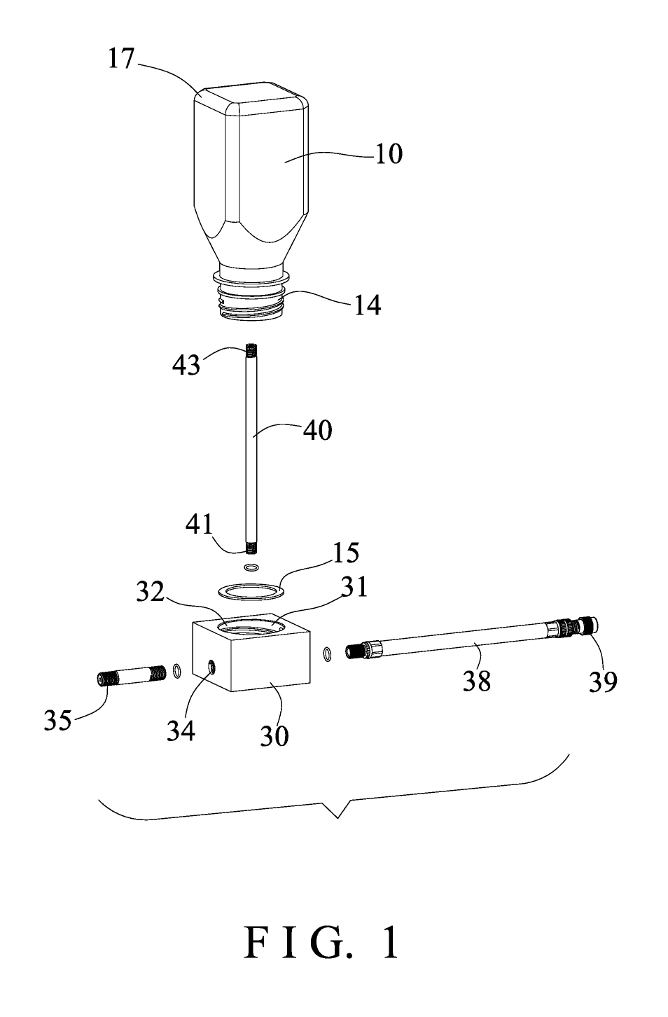

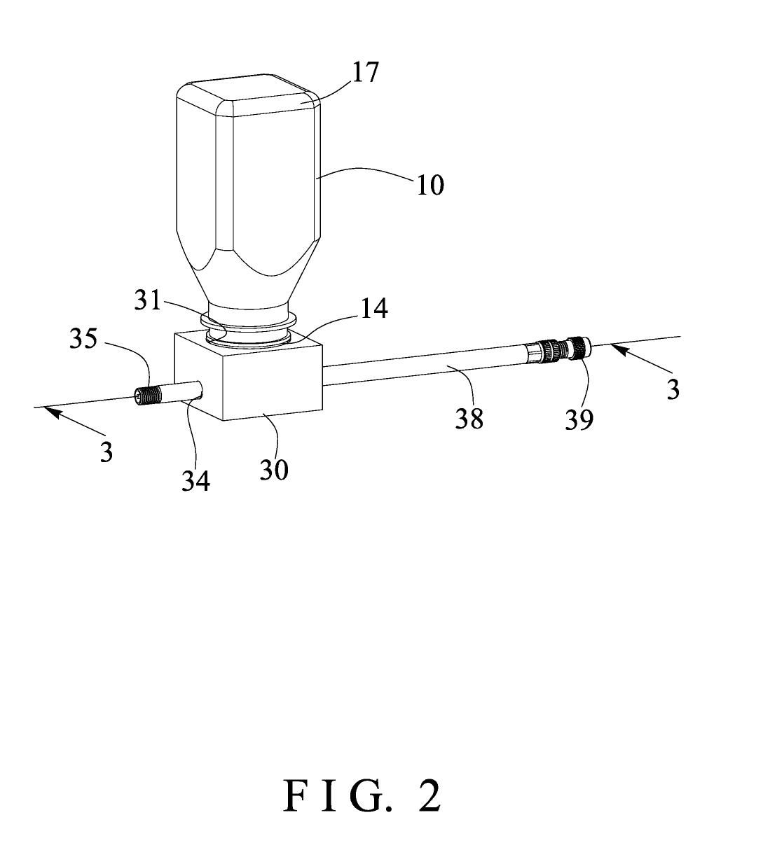

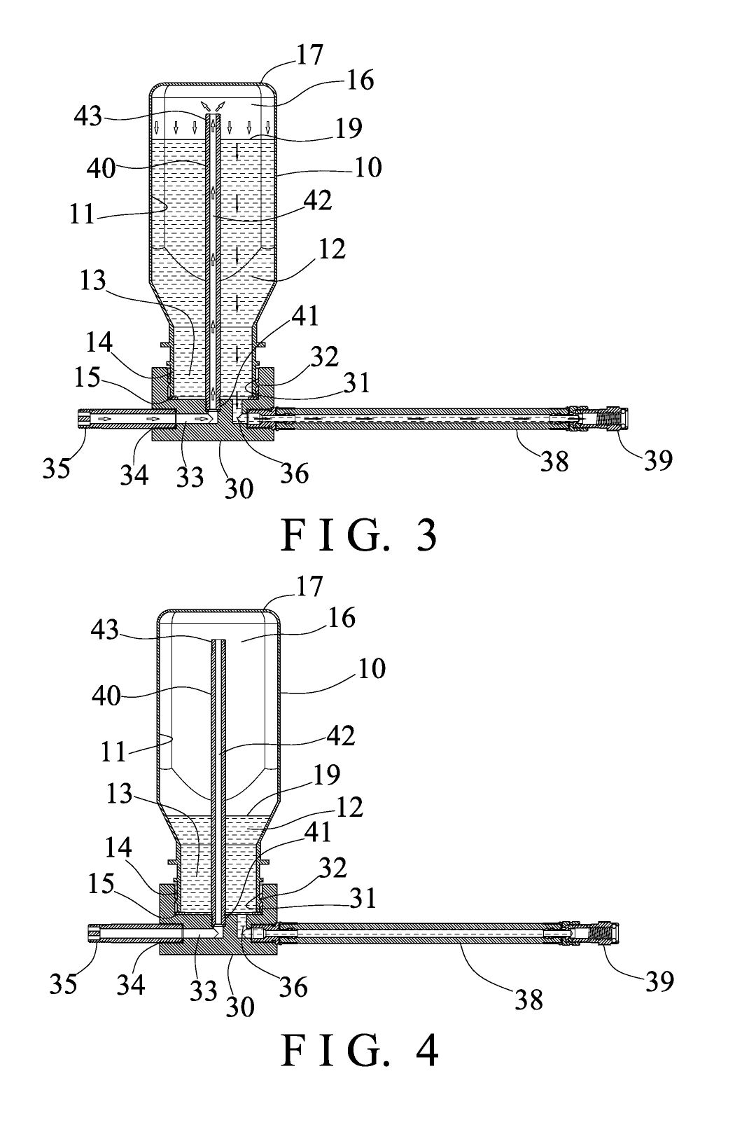

Referring to the drawings, and initially to FIGS. 1-3, a tire sealant dispensing device in accordance with the present invention comprises a tire repairing container 10 provided and including a compartment or chamber 11 formed therein (FIGS. 3-4) for receiving or engaging a sealing preparation or sealant 12 and for selectively supplying the sealant 12 to seal and inflate the inflatable objects (not illustrated), such as vehicle tires, balls, air beds, air cushions, hovercrafts, etc., and including an opening or mouth 13 formed or provided on the upper or lower portion of the tire repairing container 10 (FIGS. 1 and 3-4) for filling or discharging the sealant 12 into or from the chamber 11 of the tire repairing container 10. The tire repairing container 10 may further include an outer thread 14 formed on the outer peripheral portion of the mouth 13 and/or the upper or lower portion of the tire repairing container 10.

The tire repairing container 10 further includes an outlet mouth or piece or block or casing 30 attached and secured to the mouth 13 of the tire repairing container 10 with latches or fasteners (not shown), adhesive materials or threading engagements 14, for example, the casing 30 includes a chamber or compartment 31 formed therein for receiving or engaging the mouth 13 of the tire repairing container 10, and the casing 30 includes an inner thread 32 formed therein for threading or engaging with the outer thread 14 at the mouth 13 of the tire repairing container 10 and for detachably attaching or mounting or securing the casing 30 to the mouth 13 of the tire repairing container 10, and for blocking or enclosing the mouth 13 of the tire repairing container 10 and for confining and retaining the sealant 12 within the chamber 11 of the tire repairing container 10.

A gasket or sealing ring or washer 15 is preferably provided and attached or mounted or engaged between the mouth 13 of the tire repairing container 10 and the casing 30 for making an air or water or fluid tight seal between the mouth 13 of the tire repairing container 10 and the casing 30. Normally, the sealant 12 has not been and will not be fully filled within the chamber 11 of the tire repairing container 10, and a space 16 will be formed in the base portion 17 of the tire repairing container 10 when the tire repairing container 10 is disposed upside down, best shown in FIGS. 3-4, or when the mouth 13 and the casing 30 are located at the lower portion of the tire repairing container 10. As shown in FIGS. 3-4, the casing 30 includes an inlet manifold or conduit 33 formed therein and communicating with the compartment 31 of the casing 30 and communicating with the chamber 11 of the tire repairing container 10.

The casing 30 includes an entrance 34 communicating with the inlet conduit 33 for attaching or securing or coupling to an inlet tube 35 or a pressurized air reservoir (not illustrated), and for allowing the pressurized air from the pressurized air reservoir to be suitably supplied to the inlet conduit 33 of the casing 30 and then into the chamber 11 of the tire repairing container 10. As shown in FIGS. 1 and 3-4, a pipe 40 is disposed in the chamber 11 of the tire repairing container 10, and includes one or lower portion or first end 41 attached or mounted or secured or coupled to the inlet conduit 33 of the casing 30, and includes a bore 42 formed therein and communicating with the inlet conduit 33 of the casing 30 for directing or guiding the pressurized air to flow through the bore 42 of the pipe 40 and then to flow into the space 16 in the lower or the upper or the base portion 17 of the tire repairing container 10 (FIG. 3).

The casing 30 further includes an outlet conduit 36 formed therein and communicating with the compartment 31 of the casing 30 and also communicating with the chamber 11 of the tire repairing container 10, but offset from the inlet conduit 33 and the entrance 34 of the casing 30 for allowing the sealant 12 in the chamber 11 of the tire repairing container 10 to selectively flow out through the outlet conduit 36 of the casing 30, for example, the outlet conduit 36 of the casing 30 may be coupled to the air facilities or inflatable objects (not illustrated), such as tires, air beds, air cushions, hovercrafts, etc. with a hose 38 and a nozzle 39, and thus for allowing the pressurized air to be suitably supplied into the chamber 11 of the tire repairing container 10, and then to force the sealant 12 in the chamber 11 of the tire repairing container 10 to flow to and to inflate the inflatable objects (not illustrated) or vehicle tires or the like.

In operation and before using, the casing 30 may be disposed or located above the tire repairing container 10, and the casing 30 will be disposed or located below the tire repairing container 10 when in use. At this moment, as shown in FIGS. 3 and 4, the pipe 40 is extended toward the upper or the base portion 17 of the tire repairing container 10, and the inner portion or the upper or second end 43 of the pipe 40 is located above the fluid level 19 of the sealant 12 and is exposed such that the pressurized air from the inlet conduit 33 of the casing 30 may directly flow through the bore 42 of the pipe 40 and then flow into the space 16 that is formed in the base portion 17 of the tire repairing container 10, without flowing through the sealant 12 (FIG. 3).

The pressurized air supplied into the space 16 that is formed in the base portion 17 of the tire repairing container 10 may then force the sealant 12 to flow out through the outlet conduit 36 of the casing 30 and the hose 38. It is to be noted that the tire sealant dispensing device includes an improved and simplified structure or configuration that may be made or manufactured with a greatly decreased manufacturing cost and a reduced making or manufacturing procedure.

Accordingly, the tire sealant dispensing device includes an air compressing device including an improved tire sealant dispensing device including an improved and simplified tire repairing container for quickly coupling and attaching and securing to a pressurized air reservoir and for allowing the tire sealant to be effectively supplied to seal and inflate the inflatable objects.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tire sealant dispensing device comprising:
a tire repairing container including a chamber formed therein for receiving a sealant, and including a mouth formed therein,
a casing attached to said mouth of said tire repairing container, and said casing including a compartment formed therein for engaging said mouth of said tire repairing container, and said casing including an inlet conduit formed therein and communicating with said compartment of said casing and communicating with said chamber of said tire repairing container for guiding a pressurized air to flow through said inlet conduit of said casing and then into said chamber of said tire repairing container, and said casing including an outlet conduit formed therein and communicating with said compartment of said casing and said chamber of said tire repairing container for allowing the sealant in said chamber of said tire repairing container to selectively flow out through said outlet conduit of said casing, and
a pipe disposed in said chamber of said tire repairing container, and said pipe including a first end coupled to said casing, and said pipe including a bore formed therein and communicating with said inlet conduit of said casing for directing and guiding the pressurized air to flow through said bore of said pipe and to flow into a base portion of said tire repairing container.

2. The tire sealant dispensing device as claimed in claim 1, wherein said casing includes an entrance formed therein and communicating with said inlet conduit of said casing for coupling to an inlet tube.

3. The tire sealant dispensing device as claimed in claim 1, wherein said casing includes an outlet tube coupling to said outlet conduit of said casing.

4. The tire sealant dispensing device as claimed in claim 1, wherein said tire repairing container includes an outer thread formed on an outer peripheral portion of said mouth, and said casing includes an inner thread formed therein for engaging with said outer thread of said tire repairing container and for detachably attaching said casing to said mouth of said tire repairing container.
